(19) United States
(12) Patent Application Publication
(10) Pub. No.: US 2013/0254187 A1
(43) Pub. Date: Sep. 26, 2013

(54) DEVICE, METHOD, AND NON-TRANSITORY COMPUTER-READABLE MEDIUM FOR SEARCHING DATABASE

(71) Applicant: FUJIFILM CORPORATION, Tokyo (JP)

(72) Inventor: Keiji SUGIHARA, Tokyo (JP)

(73) Assignee: Fujifilm Corporation, Tokyo (JP)

(21) Appl. No.: 13/846,736

(22) Filed: Mar. 18, 2013

(30) Foreign Application Priority Data
Mar. 23, 2012 (JP) 2012-066979

(51) Int. Cl. G06F 17/30

(52) U.S. Cl. CPC G06F 17/3053
USPC 707/723

(57) ABSTRACT

A database search device, including: a database adapted to have information registered therein; a search reception section adapted to receive an input of a search condition; a search section adapted to search the database based on the search condition received in the search reception section; a search result output section adapted to output search result by the search section together with the search condition; a search result accumulation section adapted to accumulate the search result by the search section together with the search condition; a search result editing section adapted to edit the search result accumulated in the search result accumulation section according to a preset editing condition; and an edited search result output section adapted to output the search result edited in the search result editing section as an edited search result.

### BACKGROUND OF THE INVENTION

1. Field of the Invention

The present invention relates to a device, method and non-transitory computer-readable medium for searching a database, and more particularly relates to a device, method and non-transitory computer-readable medium for searching a case database in which case information including a case image and diagnostic information on the case image was registered.

2. Description of the Related Art

In a medical field, images obtained by modalities, such as X-ray plain radiography devices and CT (Computed Tomography), MR (Magnetic Resonance), PET (Positron Emission Tomography) and ultrasonic photography devices, are indicated on a display, and observation (diagnostic reading) of shadows in the images is performed to diagnose the presence, type and state of diseases.

As a technique to aid such a diagnosis, there is known a technique to extract out of a database a case having features similar to those of an image obtained by an examination and to display the extracted case as reference information for use in diagnostic reading.

For example, Japanese Patent Application Laid-Open No. 2002-230518 proposes a device adapted to extract a lesion position from a diagnosing image, calculate a feature value that expresses a radiographic feature of the extracted lesion position, and collate the calculated feature value with feature values of case images accumulated in the database so as to obtain similarity degrees of the case images with respect to the diagnosing image, and to extract and display the case images with high similarity degrees.

Japanese Patent Application Laid-Open No. 7-56947 proposes a system that is capable of storing, in a database, data such as clinical history outlines of past actual patients and medical examination information thereon and is capable of searching the database for information such as a corresponding clinical history outline and medical examination information by using, as a key, the information indicating a medical condition feature of a patient under examination.

In such a case search, when desired case information is not acquired with a condition specified by a user, multiple searches are performed with varied conditions. However, when multiple searches are performed, it becomes complicated to refer to search results.

The present invention has been made in view of such circumstances, and an object of the present invention is to provide a device, method and non-transitory computer-readable medium for searching a database which can efficiently acquire desired information.

### SUMMARY OF THE INVENTION

A first aspect of a database search device is an aspect including: a database adapted to have information registered therein; a search reception section adapted to receive an input of a search condition; a search section adapted to search the database based on the search condition received in the search reception section; a search result output section adapted to output search result by the search section together with the search condition; a search result accumulation section adapted to accumulate the search result by the search section together with the search condition; a search result editing section adapted to edit the search result accumulated in the search result accumulation section according to a preset editing condition; and an edited search result output section adapted to output the search result edited in the search result editing section as an edited search result.

According to this aspect, when a search is performed, the search result is accumulated together with the search condition. The accumulated search result is sequentially edited according to a preset editing condition, and is sequentially outputted as an edited search result together with the search result. For example, when an appearance ratio is prescribed as an editing condition, information with a higher appearance ratio is outputted as an edited result. Moreover, when a set intersection is prescribed as an editing condition for example, information retrieved based on all the search conditions is outputted as an edited result. Accordingly, even when multiple searches are performed, the search results can easily be referred, so that desired information can efficiently be acquired.

A second aspect of the database search device is an aspect according to the first aspect further including an editing condition reception section adapted to receive setting of the editing condition.

According to this aspect, an editing condition can arbitrarily be set. This makes it possible to efficiently obtain the information desired by a user.

A third aspect of the database search device is an aspect according to the first or second aspect, wherein the search result output section outputs search results accumulated in the search result accumulation section as a list.

According to this aspect, the search results are outputted as a list. This makes it possible to grasp past search conditions and search results so as to implement an efficient search.

A fourth aspect of the database search device is an aspect according to any one of the first to third aspects, further including an editing target selection section adapted to select search result for use in edition, wherein the search result editing section edits only the search result selected in the editing target selection section.

According to this aspect, search result for use in edition can be selected. This makes it possible to obtain desired information still more efficiently.

A fifth aspect of the database search device is an aspect according to any one of the first to fourth aspects, further including a ranking section adapted to rank search result according to a ranking condition set for every search condition, wherein the search result editing section edits search result that is within preset ranks.

According to this aspect, edition can be performed by using only the information in the top ranked search result. This makes it possible to obtain desired information still more efficiently.

A sixth aspect of the database search device is an aspect according to the fifth aspect, further including a ranking condition reception section adapted to receive setting of the ranking condition.

According to this aspect, a ranking condition can arbitrarily be set. This makes it possible to obtain desired information still more efficiently.

A seventh aspect of the database search device is an aspect according to any one of the first to sixth aspects, wherein the information registered into the database includes a case image and diagnostic information on the case image.

According to this aspect, a case image and diagnostic information on the case image can be a search target. This makes it possible to efficiently obtain a desired case at the time of a diagnosis.

A first aspect of a method for searching a database executed by a computer is an aspect including: a step of receiving an input of a search condition; a step of searching the database based on the search condition; a step of outputting search result together with the search condition; a step of accumulating the search result together with the search condition; a step of editing the accumulated search result according to a preset editing condition; and a step of outputting the edited search result as an edited search result.

According to this aspect, when a search is performed, the search result is accumulated together with the search condition. The accumulated search result is sequentially edited according to a preset editing condition, and is sequentially outputted as an edited search result together with the search result. For example, when an appearance ratio is prescribed as an editing condition, information with a higher appearance ratio is outputted as an edited result. Moreover, when a set intersection is prescribed as an editing condition for example, information retrieved based on all the search conditions is outputted as an edited result. Accordingly, even when multiple searches are performed, the search results can easily be referred, so that desired information can efficiently be acquired.

A second aspect of the method for searching a database is an aspect according to the first aspect, further including a step of receiving setting of the editing condition.

According to this aspect, an editing condition can arbitrarily be set. This makes it possible to efficiently obtain the information desired by a user.

A third aspect of the method for searching a database is an aspect according to the first or second aspect, wherein in the step of outputting the search result together with the search condition, accumulated search results are outputted as a list.

According to this aspect, the search results are outputted as a list. This makes it possible to grasp past search conditions and search results so as to implement an efficient search.

A fourth aspect of the method for searching a database is an aspect according to any one of the first to third aspects, further including a step of selecting search result for use in edition, wherein in the step of editing the search result, only the selected search result is edited.

According to this aspect, search result for use in edition can be selected. This makes it possible to obtain desired information still more efficiently.

A fifth aspect of the method for searching a database is an aspect according to the fourth aspect, further including a step of ranking search result according to a ranking condition set for every search condition, wherein in the step of editing the search result, search result that is within preset ranks are edited.

According to this aspect, edition can be performed by using only the information in the top ranked search result. This makes it possible to obtain desired information still more efficiently.

A sixth aspect of the method for searching a database is an aspect according to the fifth aspect, further comprising a step of receiving setting of the ranking condition.

According to this aspect, a ranking condition can arbitrarily be set. This makes it possible to obtain desired information still more efficiently.

A seventh aspect of the method for searching a database is an aspect according to any one of the first to sixth aspects, wherein the information registered into the database includes a case image and diagnostic information on the case image.

According to this aspect, a case image and diagnostic information on the case image can be a search target. This makes it possible to efficiently obtain a desired case at the time of a diagnosis.

One aspect of a non-transitory computer-readable medium storing a database search program causes a computer to execute the method for searching a database according to any one of the first to seventh aspects.

According to the present invention, the method for searching a database according to any one of the first to seventh aspects can be executed by a computer.

According to the present invention, desired information can efficiently be obtained.

### BRIEF DESCRIPTION OF THE DRAWINGS

FIG. 1 is a system configuration view showing one embodiment of a diagnosis aiding system with the present invention applied thereto;

FIG. 2 is a system configuration view showing the schematic configuration of a medical examination system;

FIG. 3 is a view showing the diagnosis aiding system with an emphasis being given to a case search function;

FIG. 4 is a view showing one example of case information; and

FIG. 5 is a view showing one indication example of a search result and an edited search result.

### DETAILED DESCRIPTION OF THE PREFERRED EMBODIMENTS

Hereinafter, preferable embodiments of the present invention are described in detail with reference to accompanying drawings.

<<System Configuration>>

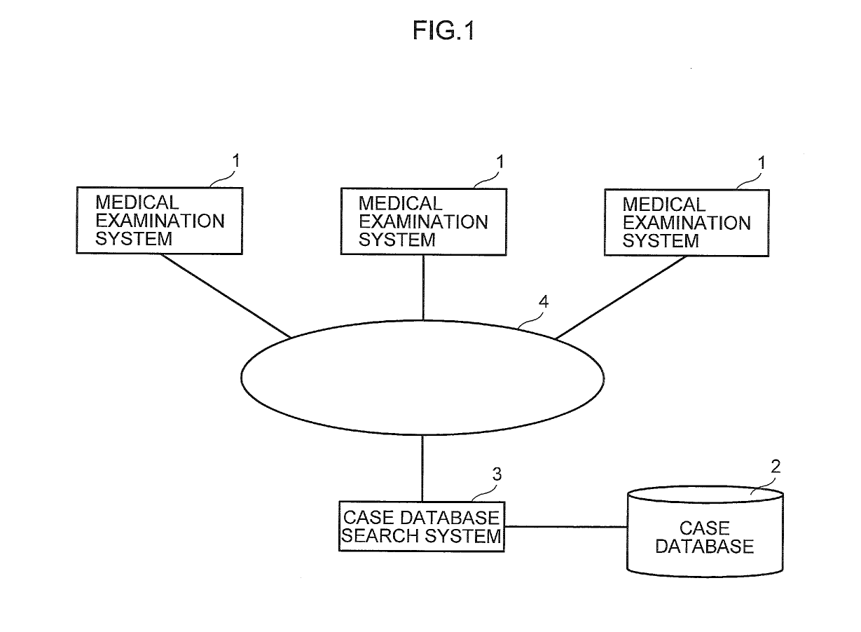

FIG. 1 is a system configuration view showing one embodiment of a diagnosis aiding system with the present invention applied thereto.

As shown in the drawing, the diagnosis aiding system mainly includes a medical examination system 1 that generates and manages medical examination information in hospitals and clinics, a case database 2 having case information registered therein, a case database search system 3 that searches the case database 2, a network 4 (Internet line or dedicated line) that connects the medical examination system 1 and the case database search system 3.

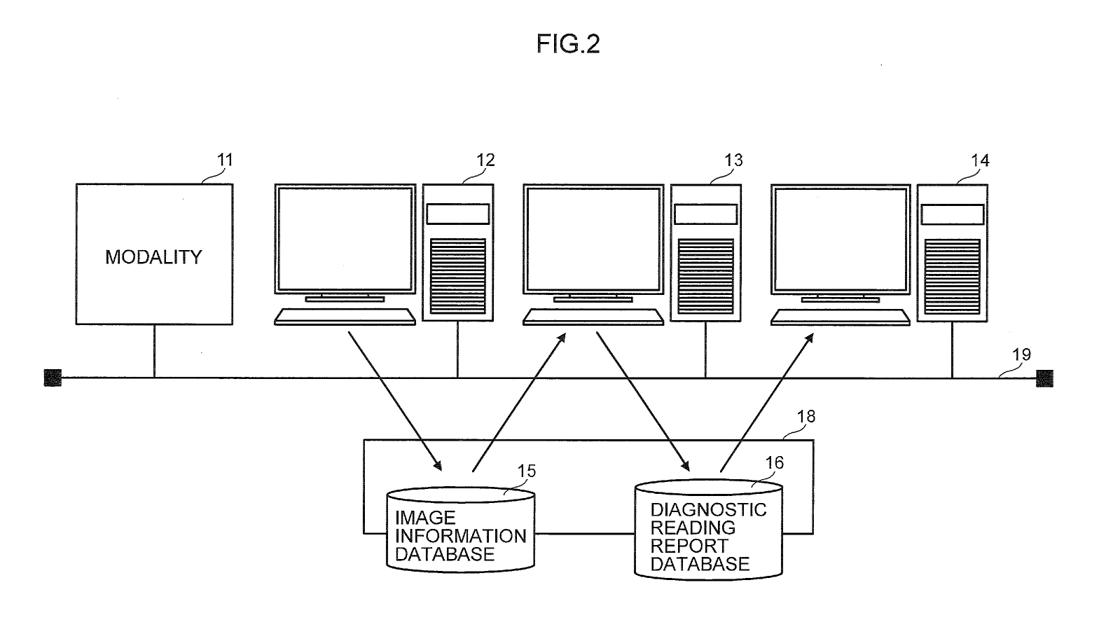

FIG. 2 is a system configuration view showing the schematic configuration of the medical examination system.

As shown in the drawing, the medical examination system 1 includes an imaging device (hereinafter referred to as “modality”) 11, an inspecting engineer workstation 12, a radiologist workstation 13, an examination doctor workstation 14, an image information database 15, a diagnostic reading report database 16, and a database management system (hereinafter referred to as “DBMS”) 18 that manages these three kinds of databases. The respective devices are connected so as to communicate with each other through the local area network 19.

In FIG. 2, the medical examination system 1 is composed of each one device connected to the local area network 19 for the sake of convenience. However, a plurality of and various types of modalities are connected to the local area network 19. Corresponding to the number of inspecting engineers, radiologists, and examination doctors, a plurality of the inspecting engineer workstations 12, the radiologist workstations 13, and the examination doctor workstations 14 are connected thereto.

The modality 11 is a device that takes an image of an object to generate image data and adds attendant information prescribed based on DICOM standard to the image data to generate and output image information.

The modality 11 may be of the type that collectively executes processing ranging from imaging of the object to generation of image data and may also be of the type that includes, as a separate unit, an imaging device that records a taken image onto a record sheet and a reader that reads an image from the record sheet to generate image data. Concrete examples of the modality 11 include X-ray plain radiography devices, as well as CT, MR, PET and ultrasonic photography devices.

The inspecting engineer workstation 12 includes a processor (e.g., a general-purpose computer), one or two high definition displays, and an input device such as a keyboard/mouse. The processor incorporates a non-transitory computer-readable medium storing a software program for aiding operation of the inspecting engineers.

The inspecting engineer workstation 12 receives image information from the modality 11 by the function of the software program incorporated in a non-transitory computer-readable medium of the processor and indicates image data and the content of attendant information included in the received image information on the display for prompting an inspecting engineer to make a confirmation. The inspecting engineer workstation 12 then transfers the image information confirmed by the inspecting engineer to the DBMS 18 through the local area network 19 and requests registration of the image information into the image information database 15.

The DBMS 18 is made by incorporating a non-transitory computer-readable medium storing a software program, which provides a function of DBMS, in a general-purpose computer with a relatively high throughput. The DBMS 18 stores the data, which is requested to be registered, in a large capacity storage connected to the DBMS 18. When there is a request to access to the registered data, the DBMS 18 extracts and provides the data that matches search conditions. Data may be stored in NAS (Network Attached Storage) and SAN (Storage Area Network) which are connected to the local area network 19.

Once the DBMS 18 receives an image information registration request, the DBMS 18 formats the image information into a database format and registers the formatted image information into the image information database 15.

For example, the image information is managed as XML or SGML data and is made up of image data representing object images and attendant information that includes at least a patient ID (patient number) for identifying the object, an examination number for identifying an examination, and an image number for identifying each image. The attendant information also includes, in addition to those listed above, a unique ID (UID) assigned for every image information, an examination date and examination time when the image information was generated, a type of the modality used in the examination for obtaining the pertinent image information, patient information such as a patient name, age and sex, an examination region (radiographing region), radiography conditions (such as use of contrast media/used pigment, radiation nuclear species, and dose of radiation), and a series number or serial number allotted when a plurality of images are obtained in one examination.

Once the DBMS 18 receives an access request from the radiologist workstation 13 through the local area network 19, the DBMS 18 searches image information registered in the image information database 15 and transmits extracted image information to the radiologist workstation 13 that is a request source.

The radiologist workstation 13, which is a device used for diagnostic reading of an image by a radiologist, includes a processor, one or two high definition displays, and an input device such as a keyboard/mouse. The processor incorporates a non-transitory computer-readable medium storing a software program which provides a function of aiding a diagnosis by the radiologist (e.g., a function of automatically detecting and highlighting potential lesion portions in an image), a function of aiding preparation of diagnostic reading reports.

Once an operation is performed to request an access to a diagnostic reading target image and other information for use in a diagnosis, the radiologist workstation 13 transmits an access request to the DBMS 18 and obtains image information on the diagnostic reading target image or information required for the diagnosis. The radiologist workstation 13 indicates the obtained image information on the display and executes such processing as automatic lesion detection processing in response to a request from the radiologist.

The radiologist workstation 13 also indicates on the display a report preparation screen which aids preparation of a diagnostic reading report. The radiologist inputs a text representing findings obtained based on diagnostic reading and the content of the diagnosis according to the indication on the display. The radiologist workstation 13 generates a diagnostic reading report including the inputted information and an image used as a diagnostic reading target (hereinafter referred to as “diagnostic reading target image”). When there are a plurality of diagnostic reading target images, a representative image (hereinafter referred to as “representative image”) which exerted a largest influence over the diagnosis is recorded onto the diagnostic reading report.

The radiologist workstation 13 transfers the generated diagnostic reading report to the DBMS 18 through the local area network 19, and requests registration of the diagnostic reading report into the diagnostic reading report database 16.

Once the DBMS 18 receives the diagnostic reading report registration request, the DBMS 18 formats the diagnostic reading report into a database format and registers the formatted diagnostic reading report into the diagnostic reading report database 16.

For example, the diagnostic reading report is managed as XML or SGML data and includes image data representing a diagnostic reading target image or a representative image, information such as an examination number, a patient ID (patient number), an image number, an examination date (radiography date) and an examination type (modality) which are obtained by referring to the attendant information of the image information at the time of the diagnostic reading of the image, examination region information, findings information, and diagnosis information. Among these, the image data may be a copy of the image data included in image information or may be reduced (thinned) image data made up of pixels fewer than those of the image data included in the image information. The image data may also be link information representing a storage (such as a folder) and a file name of the image data in the image information database 15. The diagnostic reading report preferably contains, together with the image data, coordinate information that indicates a region of interest (ROI) set with respect to the image data during diagnostic reading. The coordinate information indicating the region of interest may not only be recorded onto the diagnostic reading report but also in the attendant information of the image information.

The radiologist workstation 13 provides a case search function as one of the functions for aiding preparation of a diagnostic reading report. A detailed description of this function is described later.

The examination doctor workstation 14, which is a device used by an examination doctor to refer to diagnostic reading reports, includes a processor, one or two high definition displays, and an input device such as a keyboard/mouse. The processor incorporates a non-transitory computer-readable medium storing a software program which provides a function of receiving an access to the diagnostic reading report on an examination target.

Once an operation is performed to request an access to a diagnostic reading report and other information for use in a diagnosis (such as image information attached to the diagnostic reading report), the examination doctor workstation 14 transmits an access request to the DBMS 18.

Once the DBMS 18 receives the access request from the examination doctor workstation 14, the DBMS 18 searches the diagnostic reading reports registered into the diagnostic reading report database 16 and transmits an extracted diagnostic reading report to the examination doctor workstation 14 that is a request source.

The examination doctor workstation 14 receives the transmitted diagnostic reading report and indicates the information on the display.

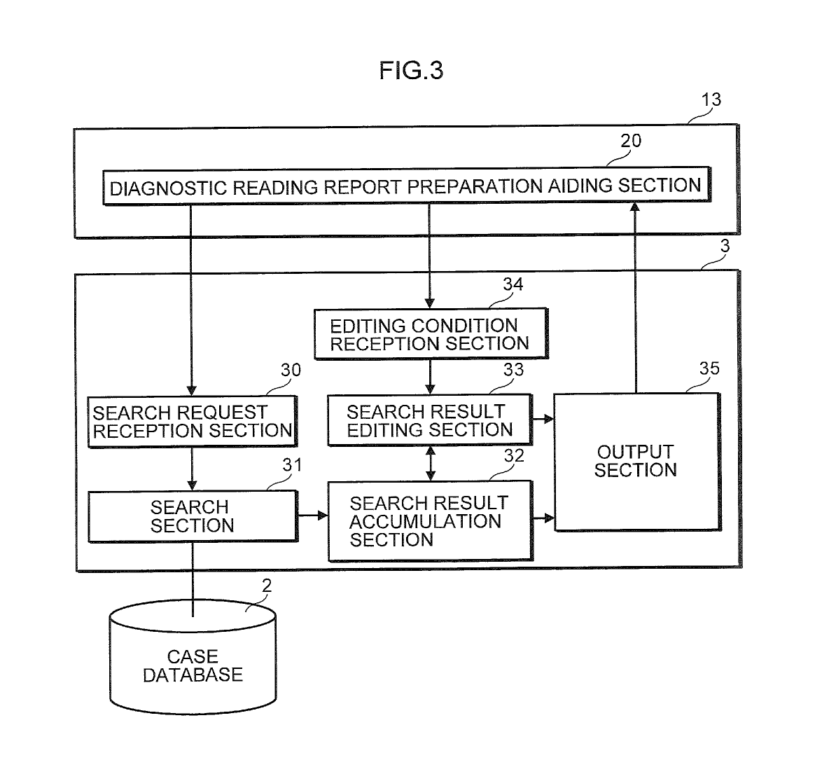

FIG. 3 is a view showing the diagnosis aiding system with an emphasis being given to the case search function.

The radiologist workstation 13 includes a diagnostic reading report preparation aiding section 20 so as to provide a function of aiding preparation of a diagnostic reading report. As one of the functions for aiding preparation of the diagnostic reading report, a case search function is provided. That is, cases can be referred when the diagnostic reading report is prepared.

The diagnostic reading report preparation aiding section 20 is provided by incorporating a specified diagnostic reading report preparation aiding program into a non-transitory computer-readable medium of a processor of the radiologist workstation 13. The radiologist workstation 13 is thereby operated as the diagnostic reading report preparation aiding section 20.

The diagnostic reading report preparation aiding section 20 receives an input of a search query and a search result editing condition from an input device such as a keyboard/mouse. The diagnostic reading report preparation aiding section 20 then transmits the inputted search query and editing condition to the case database search system 3.

The case database search system 3 is configured by incorporating a non-transitory computer-readable medium storing a software program that provides a function of DBMS into a general-purpose computer with a relatively high throughput. The case database search system 3 includes a search request reception section 30, a search section 31, a search result accumulation section 32, a search result editing section 33, an editing condition reception section 34, and an output section 35. The function of each of the search request reception section 30, the search section 31, the search result accumulation section 32, the search result editing section 33, the editing condition reception section 34, and the output section 35 is provided by incorporating a non-transitory computer-readable medium storing a software program that implements the function of each section into the computer that constitutes the system.

The search request reception section 30 receives the search query transmitted from the radiologist workstation 13 and feeds the received search query to the search section 31.

The search section 31 searches the case database 2 based on the fed search query.

In this case, the case database 2 has case information registered in a specified data format (e.g., XML and SGML), and the search section 31 extracts the case information that matches the search query.

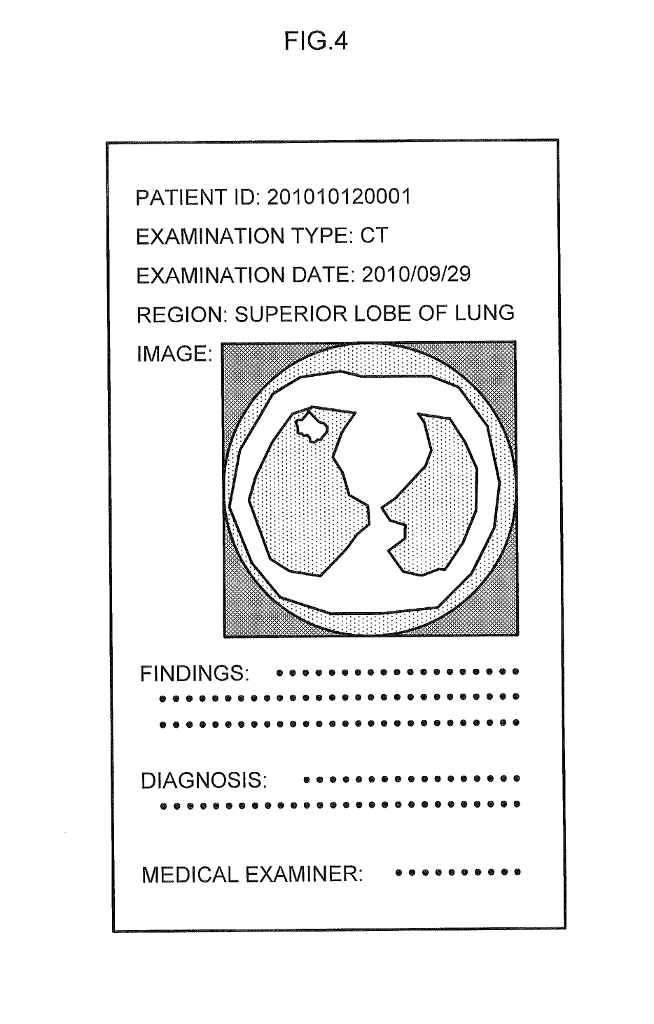

For example, the case information includes a case image and diagnostic information (such as an examination type, an examination region, findings, and a diagnosis) thereon as shown in FIG. 4 and is managed as data in a specified format (XML and SGML data).

Therefore, the search section 31 extracts, for example, case information including character information similar to the character information included in the search query, or case information including image information similar to the image information included in the search query.

The search section 31 outputs search result to the search result accumulation section 32 together with the search query.

The search result accumulation section 32 acquires the search result by the search section 31, and accumulates them together with the search query.

The search result editing section 33 edits search result accumulated in the search result accumulation section 32 according to a preset editing condition.

The editing condition reception section 34 receives the editing condition from the radiologist workstation 13 and feeds it to the search result editing section 33.

As the editing condition, an arbitrary condition, such as an appearance ratio (processing to rearrange the results in order of case conditions with a higher appearance ratio) and a set intersection (processing to extract case conditions included in all the search results), can be set.

As described above, the diagnostic reading report preparation aiding section 20 in the radiologist workstation 13 receives an input of the editing condition for the search result. The editing condition is set, for example, by indicating an editing condition setting screen on a display and inputting or selecting a desired editing condition with a mouse or a keyboard. The present embodiment is configured such that selectable editing conditions are prepared in advance and a user can arbitrarily select the conditions.

The search result editing section 33 edits the search result according to the editing condition received in the editing condition reception section 34. The search result editing section 33 then feeds the edited search result to the output section 35 as an edited search result.

The output section 35 acquires the search result from the search result accumulation section 32 while acquiring the edited search result from the search result editing section 33. The output section 35 then outputs the acquired search result and edited search result to the radiologist workstation 13.

The search result and the edited search result outputted from the output section 35 are received in the diagnostic reading report preparation aiding section 20 of the radiologist workstation 13 and are indicated on the display in a specified indication format.

<<Search Method>>

A description is now given of case search procedures. The diagnostic reading report preparation aiding section 20 in the radiologist workstation 13 indicates a specified search screen on a display. For example, the screen is indicated together with a diagnostic reading report.

The diagnostic reading report preparation aiding section 20 receives the information specified by mouse click or the like on the display screen or the information inputted from a keyboard as a search query. For example, character information such as “gastric inflammation” and “gastric ulcer” is set as a search query. When a diagnosing image indicated on the diagnostic reading report is specified by mouse click or the like, the diagnosing image is set as a search query. Further, when a region of interest is specified on the diagnosing image, feature amount data extracted from the region of interest is set as a search query.

In the present embodiment, a plurality of character information pieces and image information pieces can be set as a search query.

Once a search query is set, the diagnostic reading report preparation aiding section 20 generates a search request including the set search query, and transmits the search request to the case database search system 3.

The search request reception section 30 in the case database search system 3 feeds the search query included in the received search request to the search section 31.

The search section 31 searches the case database 2 based on the fed search query. The search section 31 then outputs search result to the search result accumulation section 32 together with information of the search query.

The search result accumulation section 32 acquires the search result outputted from the search section 31. The search result accumulation section 32 then accumulates the acquired search result together with the search query.

When a new search result is accumulated in the search result accumulation section 32, the search result editing section 33 edits the search result accumulated in the search result accumulation section 32 and generates an edited search result.

In this case, edition of the search result performed in the search result editing section 33 is based on a preset editing condition. The editing condition is preset in the radiologist workstation 13, and is received in the editing condition reception section 34.

For example, when an “appearance ratio” is set as an editing condition, the retrieved case information pieces are rearranged in order of the appearance ratios.

Moreover, when a “set intersection” is set as an editing condition for example, the case conditions extracted in all the searches are extracted.

The search result editing section 33 outputs the edited search result to the output section 35 as an edited search result.

The output section 35 acquires the edited search result outputted from the search result editing section 33. Upon reception of the edited search result, the output section 35 acquires from the search result accumulation section 32 accumulated detection results together with their search query. The output section 35 then outputs the acquired search results and the edited search result to the radiologist workstation 13.

The radiologist workstation 13 acquires the search result and the edited search result outputted from the case database search system 3, and indicates them on a display in a specified indication format.

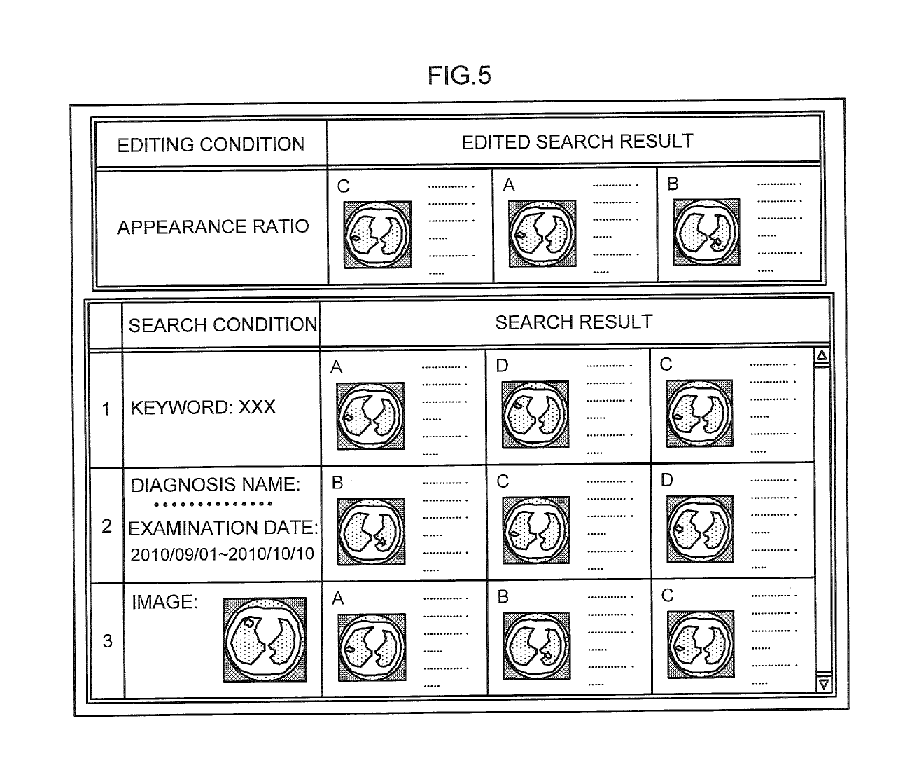

FIG. 5 is a view showing one indication example of a search result and an edited search result.

In this example as shown in the drawing, the edited search result and the search result is indicated in parallel with each other.

The edited search result is indicated so that a set editing condition and edited search results based on the set editing condition are concurrently indicated. In this example, an “appearance ratio” is set as an editing condition. In this case, the results are indicated in order of higher appearance ratios. In this example, an indicating condition is limited so that the information on the top three cases in terms of the appearance ratio is set to be displayed.

Moreover, the search results including past search results are indicated as a list. In this example, search results are set to be indicated in order of newer searches. The search results are older toward the bottom side (the newest search result being indicated on the top while the oldest search result on the bottom).

When all the search results cannot be indicated in one screen, they may be indicated, for example, by being scrolled.

Since edited search results are indicated in this way, search results can easily be referred even when multiple searches are performed, so that desired information can efficiently be acquired.

By indicating the edited search results in combination with the search results together with their search condition (search query), the search results can easily be referred, so that desired information can efficiently be acquired. In this case, by indicating the search results including the past search results as a list, it becomes possible to easily grasp a search history and to thereby acquire desired information still more efficiently.

Moreover, allowing arbitrary setting of an editing condition enables a user to efficiently acquire the information that the user truly needs.

It is to be noted that the indicating format shown in FIG. 5 is merely an example, and other indicating formats may be employed instead.

Although the example shown in FIG. 5 is configured to indicate past search results (accumulated search results) as a list, it is also possible to configure so that only the newest search results are indicated.

Although a limited number of edited search results are indicated in the example shown in FIG. 5, it is also possible to configure so that all the edited search results are indicated. It is to be noted that desired search results can be acquired more efficiently by indicating a limited number of edited search results as in the example shown in FIG. 5.

When a limited number of edited search results are indicated, it is preferable to enable the user to arbitrarily set the limited number.

It is also preferable to enable the user to arbitrarily set the order of edited search result indication. For example, when the set intersection is used, it is preferable to allow the edited search results to be rearranged in order of examination dates and the like. In this case, the edited search results are ranked based on a preset condition and are indicated in the ranked order (when the number of results to be indicated is limited, the limited number of the search results are indicated in the ranked order).

Moreover, importance information may be added to case information at the time of case information registration to use the importance as a ranking condition, so that the search results may be indicated in order of the importance.

It is also possible to configure so that the search results are weighted according to a search condition (search query) and edited search results are ranked thereby.

It is also preferable to configure so that the editing condition can be changed with an arbitrary timing In this case, when a new editing condition is set, search results are edited under the new editing condition. The edited search results edited under the new editing condition are indicated on the display.

It is also preferable to configure so that the edited search results can be reset with an arbitrary timing. In this case, when reset of the edited search results is instructed from a user, the search results accumulated in the search result accumulation section 32 are deleted. It is also possible to configure so that the search results are deleted after they are stored. In that case, it is preferable to configure so that past search results can be called where necessary.

In the above stated embodiments, edition of search results is implemented with use of all the past search results. However, it is also possible to allow selection of a search result for use in edition. The selection is implemented by, for example, mouse click of the search result out of listed search results. Or alternatively, edition is implemented with use of only the newest N search results (N being arbitrarily set by the user or being fixed). Thus, by employing the configuration which can limit the editing targets, it becomes possible to acquire the cases truly needed by the user still more efficiently.

In the above stated embodiments, search results are edited with use of all the search results of one search. However, it is also possible to limit the number of search results (the number of case information pieces) for use in one search. In this case, the search results are ranked according to a preset condition, and edition is performed with use of only the top ranked search results (top N cases: N being set by the user, for example).

For the ranking, the user may be set an arbitrary condition. For example, in the case of the appearance ratio, the search results may be configured to be ranked in order of higher appearance ratios. In the case of the set intersection, they may be configured to be ranked in order of examination dates (ascending order, descending order), in order of registration dates (ascending order, descending order), in order of the importance, or the like. This setting is made, for example, together with the setting of the editing condition by indicating a specified setting screen on the display.

The above-stated embodiments are configured so that input of search conditions and output of results are executed in the radiologist workstation 13 connected through the network. However, they may be configured so that input of search conditions and output of results are executed directly in the case database search system 3.

It is also possible to configure the embodiments so that input of search conditions and output of results are executed in the examination doctor workstation 14.

Furthermore in the above stated embodiments, searching for case information has been described as an example. Without being limited thereto, the present invention may also be applied to searching for other information.

What is claimed is:

1. A database search device, comprising:
a database adapted to have information registered therein;
a search reception section adapted to receive an input of a search condition;
a search section adapted to search the database based on the search condition received in the search reception section;
a search result output section adapted to output search result by the search section together with the search condition;
a search result accumulation section adapted to accumulate the search result by the search section together with the search condition;
a search result editing section adapted to edit the search result accumulated in the search result accumulation section according to a preset editing condition; and
an edited search result output section adapted to output the search result edited in the search result editing section as an edited search result.

2. The database search device according to claim 1, further comprising
an editing condition reception section adapted to receive setting of the editing condition.

3. The database search device according to claim 1, wherein
the search result output section outputs search results accumulated in the search result accumulation section as a list.

4. The database search device according to claim 1, further comprising
an editing target selection section adapted to select search result for use in edition, wherein
the search result editing section edits only the search result selected in the editing target selection section.

5. The database search device according to claim 1, further comprising
a ranking section adapted to rank search result according to a ranking condition set for every search condition, wherein
the search result editing section edits search result that is within preset ranks.

6. The database search device according to claim 5, further comprising
a ranking condition reception section adapted to receive setting of the ranking condition.

7. The database search device according to claim 1, wherein
the information registered into the database includes a case image and diagnostic information on the case image.

8. A method for searching a database executed by a computer, comprising the steps of:
receiving an input of a search condition;
searching the database based on the search condition;
outputting search result together with the search condition;
accumulating the search result together with the search condition;
editing the accumulated search result according to a preset editing condition; and
outputting the edited search result as an edited search result.

9. The method for searching a database according to claim 8, further comprising
a step of receiving setting of the editing condition.

10. The method for searching a database according to claim 8, wherein
in the step of outputting the search result together with the search condition, accumulated search results are outputted as a list.

11. The method for searching a database according to claim 8, further comprising
a step of selecting search result for use in edition, wherein
in the step of editing the search result, only the selected search result is edited.

12. The method for searching a database according to claim 8, further comprising
a step of ranking search result according to a ranking condition set for every search condition, wherein
in the step of editing the search result, search result within preset ranks is edited.

13. The method for searching a database according to claim 12, further comprising
a step of receiving setting of the ranking condition.

14. The method for searching a database according to claim 8, wherein
the information registered into the database includes a case image and diagnostic information on the case image.

15. A non-transitory computer-readable medium storing a database search program causing a computer to execute the method for searching a database according to claim 8.
